(19) United States
(12) Patent Application Publication
(10) Pub. No.: US 2015/0264198 A1
(43) Pub. Date: Sep. 17, 2015

(54) AUTOMATIC INSTALLATION SYSTEM AND METHOD, INFORMATION PROCESSING APPARATUS, AND IMAGE FORMING APPARATUS

(71) Applicant: CANON KABUSHIKI KAISHA, Tokyo (JP)

(72) Inventor: Yuka Kamiya, Machida-shi (JP)

(21) Appl. No.: 14/632,126

(22) Filed: Feb. 26, 2015

(30) Foreign Application Priority Data
Mar. 13, 2014 (JP) 2014-050535

(51) Int. Cl. H04N 1/00; H04N 1/32

(52) U.S. Cl. CPC H04N 1/0097; H04N 1/00204; H04N 1/00339; H04N 1/00965; H04N 1/00938; H04N 1/00474; H04N 1/32122; H04N 1/32577; H04N 2201/0094

(57) ABSTRACT

A project management program in a client computer associates attribute information with each of individual data, and generates a script containing a step of selecting that attribute information. An automatic installation program for an image forming apparatus executes the script and applies the individual data associated with an attribute specified through an operating panel.

### BACKGROUND OF THE INVENTION

1. Field of the Invention

The present invention relates to automatic installation systems and methods, information processing apparatuses, and image forming apparatuses for efficiently setting up a plurality of image forming apparatuses.

2. Description of the Related Art

When introducing a new image forming apparatus, it is necessary to perform setup operations at a customer's site based on the usage environment. Setup operations for image forming apparatuses require much time and effort. Accordingly, a system has been proposed in which, in the case where the same setup operations can be carried out for a plurality of image forming apparatuses, the setup operations are carried out automatically and efficiently by preparing necessary software, setting values, verification data, and the like for the usage environment in advance and processing those items in accordance with installation instruction information.

Furthermore, a system has been proposed in which, in the case where individual settings are to be made for a plurality of image forming apparatuses, a correspondence list containing target identifiers that enable target image forming apparatuses to be specified and individual data is managed by a host system, and individual setup operations are carried out in accordance with the correspondence list (see Japanese Patent Laid-Open No. 2001-510597, for example).

However, it is often the case that setting values that must be set individually for individual image forming apparatuses are determined depending on the locations of installation, departments in which the apparatuses are installed, and so on. For example, installation locations and device names will differ depending precisely on the floor, department, or the like where the apparatus is installed, and address lists and the like that are registered may differ as well. When installing image forming apparatuses at a customer site, a random image forming apparatus is normally selected from among the image forming apparatuses that have been delivered and is installed in a specified location, and installation locations and image forming apparatuses are not necessarily associated with each other in advance. In other words, individual data determined based on the installation location and the target identifier of a image forming apparatus whose installation location is not set cannot be associated with each other in advance, and such a case cannot be handled by the system proposed in Japanese Patent Laid-Open No. 2001-510597.

### SUMMARY OF THE INVENTION

Having been achieved in light of the aforementioned conventional example, the present invention provides an automatic installation system and method, an information processing apparatus, an image forming apparatus, and a program in which individual configuration information determined after an image forming apparatus is installed can be prepared in advance before the installation, and in which correct individual configuration information can be set through a simple operation.

The present invention has the following configuration.

According to the first aspect of the present invention, there is provided an automatic installation system comprising an information processing apparatus that generates a program for setting configuration information in one or more newly-installed image forming apparatuses and at least one image forming apparatus in which the configuration information is set by executing the generated program, the information processing apparatus including: an obtaining unit that obtains the configuration information to be set in an image forming apparatus to be configured; a generating unit that, in the case where the obtained configuration information includes individual configuration information set individually in the image forming apparatus to be configured and the individual configuration information is associated with an identifier of the individual configuration information, generates a first individual setting command for setting the individual configuration information in association with an input identifier when setting the configuration information in the image forming apparatus; and a storing unit that stores a program including the generated first individual setting command and the individual configuration information in a medium, and each of the at least one image forming apparatus loading the program, and including: an input unit that accepts an input of the identifier in the case where the first individual setting command is included; and a setting unit that sets the individual configuration information associated with the input identifier as the configuration information of the image forming apparatus.

According to the second aspect of the present invention, there is provided an information processing apparatus that generates a program for setting configuration information in one or more newly-installed image forming apparatuses in which configuration information is set by executing a generated program, the apparatus comprising: an obtaining unit that obtains the configuration information to be set in an image forming apparatus to be configured; a generating unit that, in the case where the obtained configuration information includes individual configuration information set individually in the image forming apparatus to be configured and the individual configuration information is associated with an identifier of the individual configuration information, generates a first individual setting command for setting the individual configuration information in association with an input identifier when setting the configuration information in the image forming apparatus; and a storing unit that stores a program including the generated first individual setting command and the individual configuration information in a medium.

According to the third aspect of the present invention, there is provide an image forming apparatus that sets configuration information by executing a program for setting the configuration information in one or more newly-installed image forming apparatuses, the image forming apparatus comprising: an input unit that, in the case where the program is loaded and a first individual setting command for setting the individual configuration information associated with an identifier input when the configuration information is set in the image forming apparatus is included, accepts an input of the identifier; and a setting unit that sets the individual configuration information associated with the input identifier as the configuration information of the image forming apparatus.

According to the present invention, the correct setup can be carried out during setup operations for an image forming apparatus even when the setup conditions are such that the networked environment cannot be used at the customer site where the image forming apparatus is installed, and the individual data to be applied and the target identifier of the image forming apparatus are determined based on the installation location.

Further features of the present invention will become apparent from the following description of exemplary embodiments (with reference to the attached drawings).

### BRIEF DESCRIPTION OF THE DRAWINGS

FIG. 1 is a diagram illustrating an example of device configurations in an automatic installation system according to the present invention.

FIG. 2 is a block diagram illustrating an exemplary configuration of the primary components of an image forming apparatus 101.

FIG. 3 is a block diagram illustrating the configuration of a client computer 103.

FIG. 4 is a block diagram illustrating the configuration of a project management server 104.

FIG. 5 is a diagram illustrating an example of the software configuration of the image forming apparatus 101.

FIG. 6 is a diagram illustrating an example of the functional configuration of an automatic installation program.

FIG. 7 is a diagram illustrating an example of the functional configuration of a project management program.

FIG. 8 is a diagram illustrating an example of a folder and a file structure within USB storage 209.

FIG. 9 illustrates an example of a script denoting a setup procedure for an image forming apparatus.

FIG. 10 is a workflow diagram illustrating setup operations for an image forming apparatus.

FIG. 11 is a workflow diagram illustrating setup post-processing for an image forming apparatus.

FIG. 12 is a diagram illustrating an example of the data structure of project data.

FIG. 13 illustrates an example of a script in which a target identifier and individual data are not associated.

FIG. 14 illustrates an example of project data in which individual data and a target identifier are not associated.

FIG. 15 illustrates an example of a script in which a target identifier and individual data are not associated.

FIG. 16 is a flowchart illustrating processing carried out by the project management program.

FIG. 17A is a flowchart illustrating processing carried out by the automatic installation program.

FIG. 17B is a flowchart for an individual data selection processing portion.

FIG. 17C is a flowchart illustrating a normal setup process.

FIG. 18 is a diagram illustrating an example of an individual data selection screen.

FIG. 19 is a diagram illustrating an example of association information in which is denoted an association between individual data and a target identifier.

FIG. 20 is a flowchart illustrating the flow of a process for updating project data.

FIG. 21 is a diagram illustrating an example of the functional configuration of a project management server program 2100.

FIG. 22 is a sequence chart illustrating operations performed between a client computer and a project management server.

### DESCRIPTION OF THE EMBODIMENTS

Hereinafter, embodiments of the present invention will be described with reference to the drawings.

### First Embodiment

### System Configuration

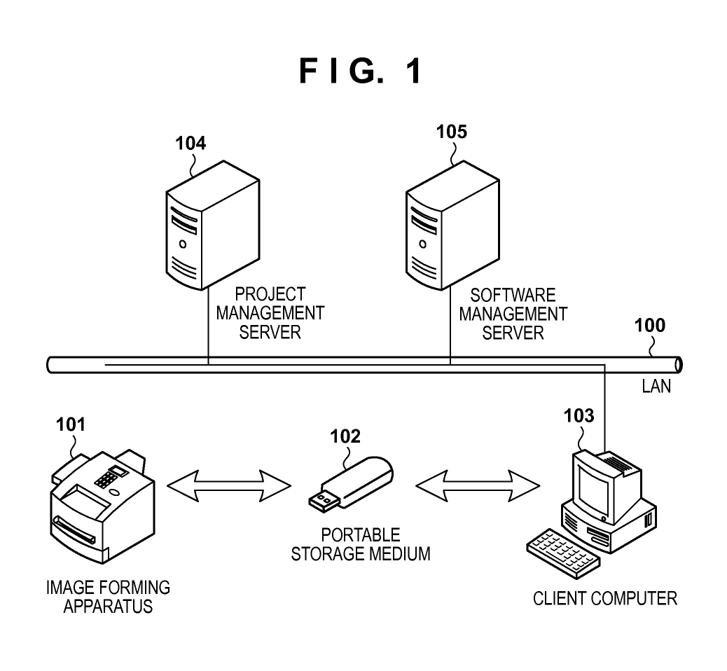

FIG. 1 is a diagram illustrating an example of device configurations in an automatic installation system according to the present invention. The automatic installation system according to the present invention is configured of a client computer 103, a project management server 104, a software management server 105 which are connected to a LAN (local area network) 100, and an image forming apparatus 101, that can exchange data via the portable storage medium 102.

Although the image forming apparatus 101 has a network interface capable of connecting to a network, the present embodiment relates to a setup process for the image forming apparatus carried out in an environment where a network cannot be used, and thus the image forming apparatus is not connected to the LAN 100. The image forming apparatus 101 is an image forming apparatus that incorporates a plurality of functions, such as a scanner, a printer, a facsimile, a file sending function, and so on into a photocopier, and is thus what is known as a multifunction peripheral (MFP). The image forming apparatus 101 includes an interface for connecting portable storage media. Although the interface for connecting portable storage media is not limited to a specific type, the present embodiment assumes that a USB interface is used. Data can be read from and written to the portable storage medium 102 by connecting the portable storage medium 102 to this interface. The portable storage medium 102 may be any type of storage device that can be easily removed from a host device, but in the present embodiment, USB storage 209 of the USB mass storage class is used.

The client computer 103 is what is known as a personal computer. The client computer 103 has an interface for connecting portable storage media. Although the interface for connecting portable storage media is not limited to a specific type, a USB interface is used in the present embodiment. Data can be read from and written to the portable storage medium 102 by connecting the portable storage medium 102 to this interface. The client computer 103 functions as an automatic setting program generation device that generates project data in which is registered setup details for the image forming apparatus 101 and generates a script for automatic settings executed by an automatic setting program, which will be mentioned later.

The project management server 104 is a server that manages the project data generated using the client computer 103. The project data will be described later. The project management server 104 may be connected to the LAN 100 directly or over the Internet. The software management server 105 is a server that manages firmware that can be used by the image forming apparatus 101, various types of license information, and so on. The software management server 105 may be connected to the LAN 100 directly or over the Internet.

### Configuration of Image Forming Apparatus

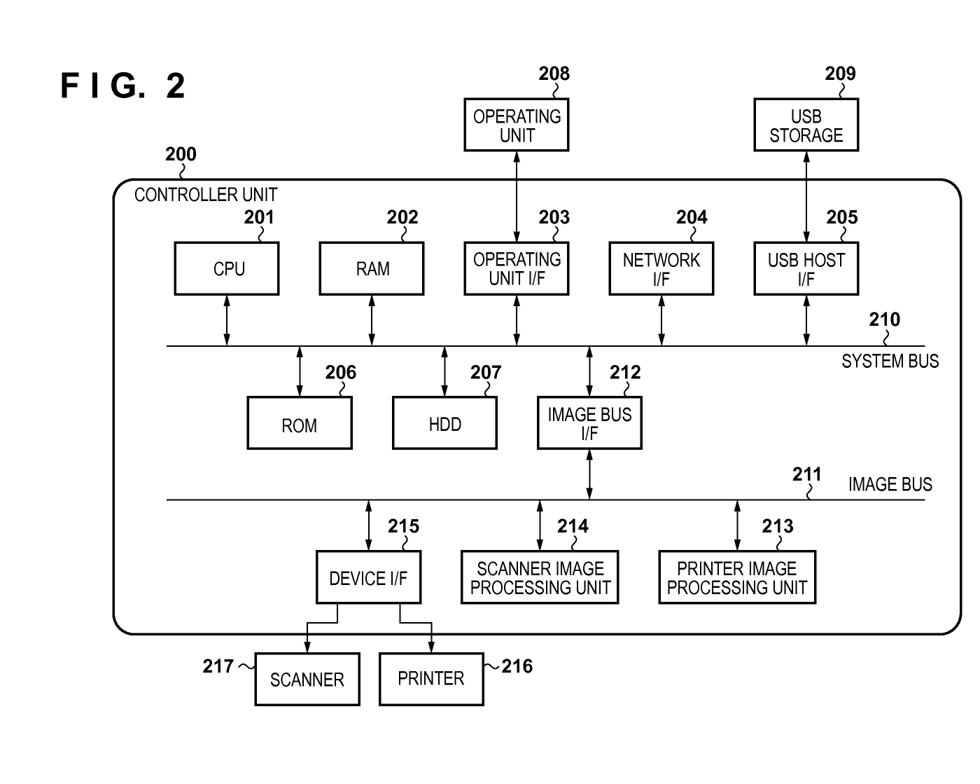

FIG. 2 is a block diagram illustrating an example of the configuration of the primary components of the image forming apparatus 101. The image forming apparatus 101 includes a controller unit 200, and a scanner 217 serving as an image input device, a printer 216 serving as an image output device, and so on, as well as an operating unit 208, are connected to the controller unit 200. The controller unit 200 carries out control for realizing a copy function that uses the printer 216 to print and output image data read by the scanner 217. The controller unit 200 includes a CPU 201, and the CPU 201 launches an operating system (OS) using a boot program stored in a ROM 206. The CPU 201 executes programs stored in an HDD (hard disk drive) 207 in the OS, and executes various types of processes as a result. A RAM 202 is used as a work area of the CPU 201. The RAM 202 provides the work area and provides an image memory area for temporarily storing image data. The HDD 207 stores the aforementioned programs, image data, and so on.

The ROM 206 and the RAM 202, an operating unit I/F (operating unit interface) 203, a network I/F (network interface) 204, a USB host I/F 205, and an image bus I/F (image bus interface) 212 are connected to the CPU 201 via a system bus 210.

The operating unit I/F 203 is an interface with the operating unit 208, which includes a touch panel, and outputs image data to be displayed in the operating unit 208 to the operating unit 208. The operating unit I/F 203 also sends information input by the user through the operating unit 208 to the CPU 201. The network I/F 204 is an interface for connecting the image forming apparatus 101 to a LAN.

The USB host I/F 205 is an interface unit that communicates with the USB storage 209. The USB host I/F 205 outputs data stored in the HDD 207 to the USB storage 209. The USB host I/F 205 also inputs data stored in the USB storage 209 and provides that data to the CPU 201. The USB storage 209 is an external storage device that stores data, and can be attached to and removed from the USB host I/F 205. A plurality of USB devices, including the USB storage 209, can be connected to the USB host I/F 205.

The image bus I/F 212 is a bus bridge for connecting the system bus 210 and an image bus 211 that transfers image data at high speeds, and converting data formats. The image bus 211 is configured of a PCI bus, IEEE 1394, or the like. A device I/F 215, a scanner image processing unit 214, and a printer image processing unit 213 are provided on the image bus 211.

The scanner 217 and the printer 216 are connected to the device I/F 215, and the device I/F 215 performs synchronous/asynchronous conversion on the image data. The scanner image processing unit 214 performs correction, processing, editing, and so on on input image data. The printer image processing unit 213 carries out correction, resolution conversion, and so on on print output image data, in accordance with the printer 216.

Computer Hardware Configuration

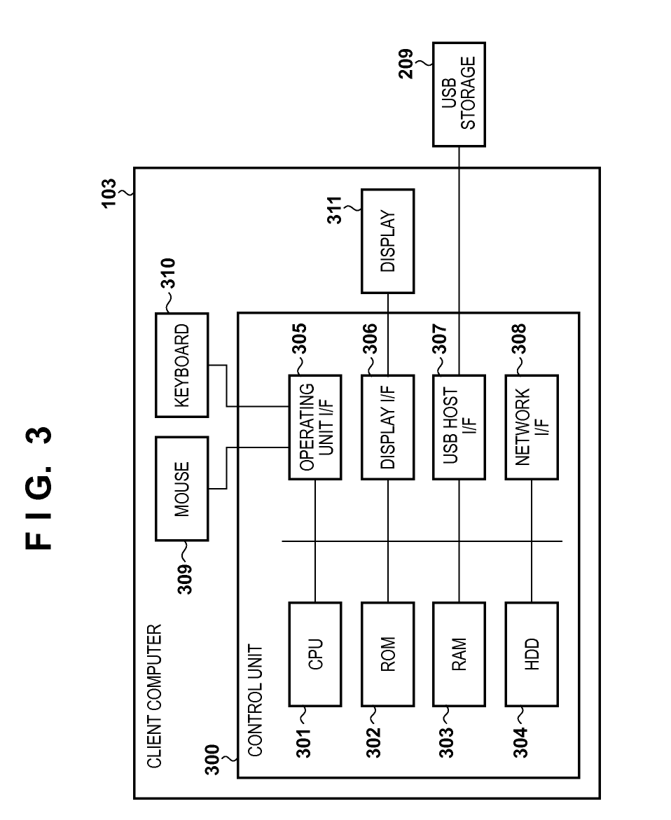

FIG. 3 is a block diagram illustrating the configuration of the client computer 103, that is, of an information processing apparatus. A control unit 300 that includes a CPU 301 controls the operations of the client computer 103 as a whole. The CPU 301 reads out control programs stored in a ROM 302 and executes various types of control processes. A RAM 303 is used as the main memory of the CPU 301, a temporary storage region such as a work area, or the like. An HDD 304 stores image data, various types of programs, and the like.

An operating unit I/F 305 is an interface that connects a user interface terminal that inputs control operations to programs executed by the client computer 103. Although configured of a mouse 309, a keyboard 310, and the like in the present embodiment, the operating unit I/F 305 is not limited thereto.

A display I/F 306 is an interface that connects a display terminal that displays UIs of programs executed by the client computer 103. Although configured of a display 311 in the present embodiment, the display I/F 306 is not limited thereto.

A network I/F 308 connects the control unit 300 to the LAN 100. The network I/F 308 exchanges various types of information with other apparatuses over the network.

A USB host I/F 307 is an interface unit that communicates with the USB storage 209. The USB host I/F 307 outputs data stored in the HDD 304 to the USB storage 209. The USB host I/F 307 also inputs data stored in the USB storage 209 and provides that data to the CPU 301. The USB storage 209 is an external storage device that stores data, and can be attached to and removed from the USB host I/F 307. A plurality of USB devices, including the USB storage 209, can be connected to the USB host I/F 307.

Server Hardware Configuration

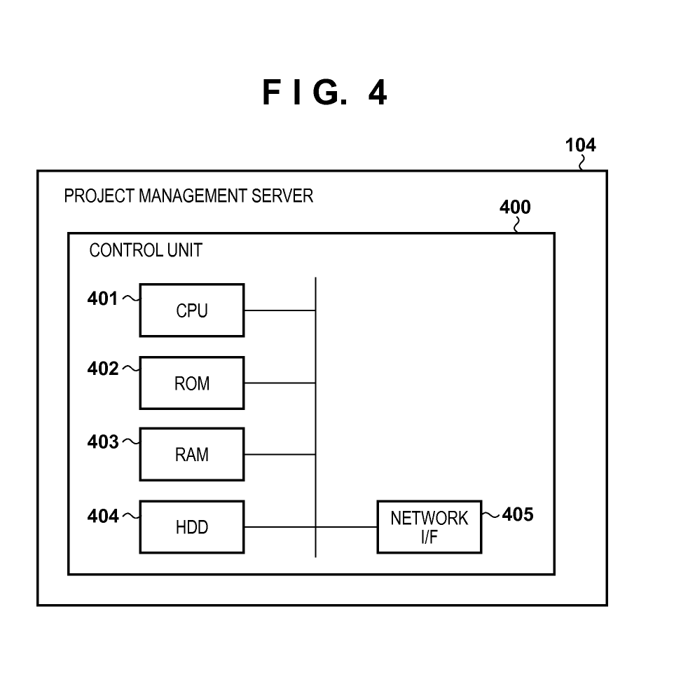

FIG. 4 is a block diagram illustrating the configuration of the project management server 104. A control unit 400 that includes a CPU 401 controls operations of the project management server 104 as a whole. The CPU 401 reads out control programs stored in a ROM 402 and executes various types of control processes. A RAM 403 is used as the main memory of the CPU 401, a temporary storage region such as a work area, or the like. An HDD 404 stores image data, various types of programs, or various types of information tables, which will be described later.

A network I/F 405 connects the control unit 400 to the LAN 100. The network I/F 405 exchanges various types of information with other apparatuses over the network. The software management server 105 has the same configuration as the project management server 104 and thus descriptions thereof will be omitted.

Software Configuration of Image Forming Apparatus

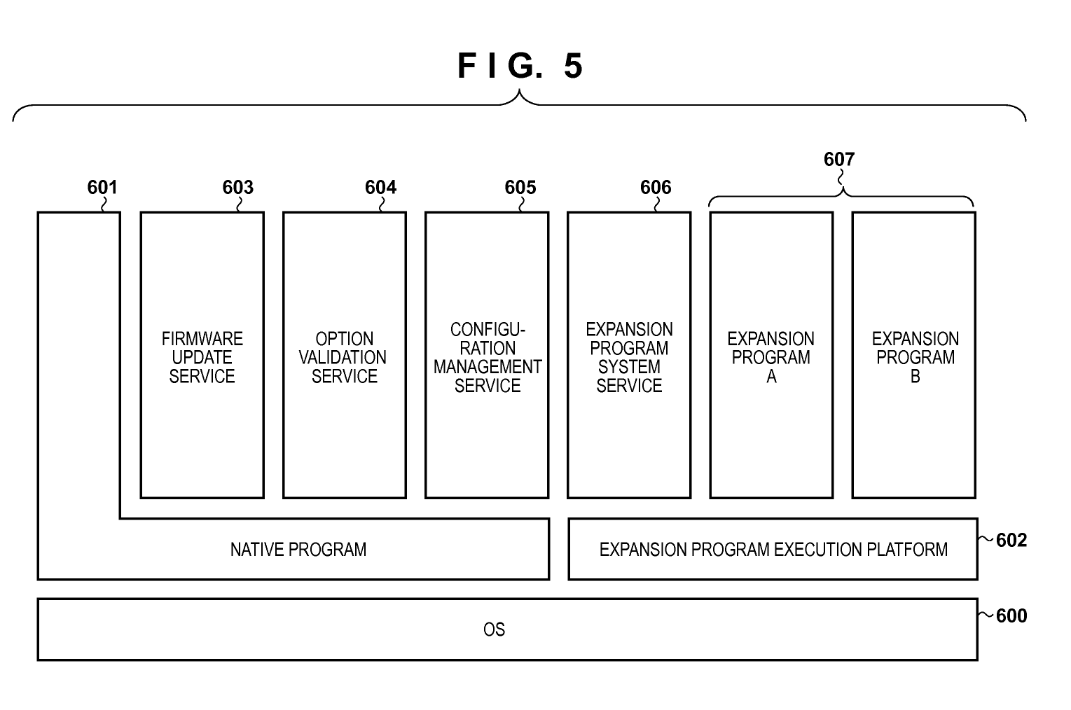

FIG. 5 is a diagram illustrating an example of the software configuration of the image forming apparatus 101. A native program 601, serving as a control program originally provided for a printer, fax, scanner, and so on, as well as an expansion program execution platform 602 serving as an execution platform for a functionality expansion program (to be referred to as an expansion program herein after), run on an OS 600. Furthermore, a firmware update service 603, an option activation service 604, and a configuration management service 605 run in the native program 601. Meanwhile, an expansion program system service 606 and expansion programs 607 run in the expansion program execution platform 602.

The firmware update service 603 is a service that provides various types of functions for updating firmware. For example, the firmware update service 603 refers to firmware specified by a user and determines whether or not it is necessary to update that firmware. The firmware update service 603 also updates the firmware in response to or via the native program 601.

The option activation service 604 is a service for activating optional functions incorporated into the native program 601 in advance. The option validation service 604 identifies and activates optional functions specified by an option license file designated by a user.

The configuration management service 605 is a service for managing various types of configuration information for the printer, scanner, and so on. The configuration management service 605 provides a function for overwriting configuration information of the native program 601 when one or more settings are made or a file containing a plurality of pieces of configuration information is designated by the user, for example. Note that the configuration management service 605 has a user interface (“UI” hereinafter), and the user can instruct settings to be changed via the operating unit 208 of the image forming apparatus 101. Furthermore, the configuration information can be provided as a file in response to a request from an expansion program, sent via the expansion program system service 606. This function will be referred to as exporting a device configuration information file hereinafter. The configuration information contains various types of settings, such as an address book and optional functions to be activated, information regarding an installation location, user account information, default setting values for various types of functions, and so on, for example. Of these, it is possible that different values are set for individual image forming apparatuses, such as settings for the address book and optional functions, installation locations, apparatus identification information, account information, and so on, for example.

The expansion program system service 606 is provided by the system, from a utility library of use for sharing expansion programs. By calling the function of the expansion program system service 606 from the expansion programs 607, the need to develop the expansion program can be eliminated. The expansion programs 607 can access other expansion programs 607, the respective modules of the image forming apparatus 101 such as the RAM 202, and so on only via the expansion program execution platform 602 or the expansion program system service 606. Meanwhile, the expansion programs 607 that have a UI can display icons in a main menu screen displayed in the operating unit 208 of the image forming apparatus 101. When the operating unit I/F 203 detects via the operating unit 208 that the user has selected these icons, the operating unit I/F 203 sends a notification thereof to the CPU 201. Having received the notification, the CPU 201 displays the UI of the expansion program selected by the user in the operating unit 208.

Note that this software configuration indicates only the basic parts, and other services and the like may be included depending on the operating environment. Furthermore, unnecessary services may be omitted for reasons such as restricting settings or the like.

Functional Configuration of Automatic Installation Program

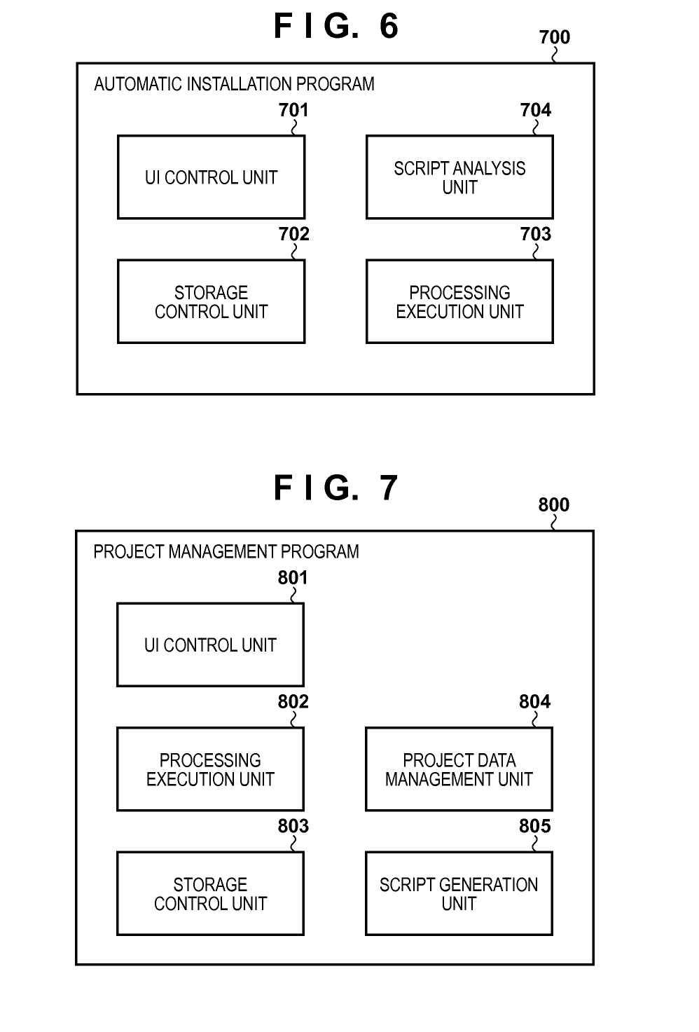

FIG. 6 is a diagram illustrating an example of the functional configuration of an automatic installation program that runs on the image forming apparatus 101. In the present embodiment, it is assumed that an automatic setting program 700 is provided as one of the expansion programs 607 of the image forming apparatus 101. The automatic installation program 700 is a program executed when the image forming apparatus is newly installed at its place of operation. The automatic installation program 700 also has a function for installing expansion programs aside from the automatic installation program 700, and is thus installed separately before other expansion programs. The CPU 201 realizes the respective functions by executing programs in accordance with those respective functions. The automatic installation program 700 includes a UI control unit 701, a storage control unit 702, a processing execution unit 703, and a script analysis unit 704. The UI control unit 701 provides a UI, for operating the automatic setting program, to the user through the operating unit 208, and accepts operations from the user. The storage control unit 702 reads/writes data from/to the USB storage 209. The storage control unit 702 also detects the USB storage 209 being attached and removed. The processing execution unit 703 carries out various types of processes in response to instructions from the UI control unit 701 and the storage control unit 702. The script analysis unit 704 analyzes a script, which is installation operation instruction information, stored in the USB storage 209, and determines processes to be executed by the processing execution unit 703 and the order of those processes.

Functional Configuration of Project Management Program

FIG. 7 is a diagram illustrating an example of the functional configuration of a project management program 800 that runs on the client computer 103. The CPU 301 realizes the respective functions by executing programs. Although the present embodiment assumes that the programs are executed by the client computer 103, the invention is not limited thereto, and the programs may be executed by a server, a service, or the like on the network, via the network I/F 308. The project management program 800 is a program having a function for, for example, generating a script executed by the automatic installation program 700 and outputting that script to a portable medium. The project management program 800 includes a UI control unit 801, a processing execution unit 802, a storage control unit 803, a project data management unit 804, and a script generation unit 805. The UI control unit 801 provides a UI for operating the project management program to an operator through the display 311, and accepts operations made by the operator through the mouse 309, the keyboard 310, and so on. The processing execution unit 802 carries out various types of processes in response to instructions from the UI control unit 801 and the storage control unit 803. The storage control unit 803 reads/writes data from/to the USB storage 209. The storage control unit 803 also detects the USB storage 209 being attached and removed. The project data management unit 804 generates project data in accordance with instructions from the processing execution unit 802 based on input information from the UI control unit 801 and sends the project data to the project management server 104, obtains project data held in the project management server 104, and so on. The script generation unit 805 generates scripts that can be analyzed by the automatic installation program 700 based on the project data generated by the project data management unit 804, in accordance with instructions from the processing execution unit 802.

File Storage Used by Automatic Installation Program

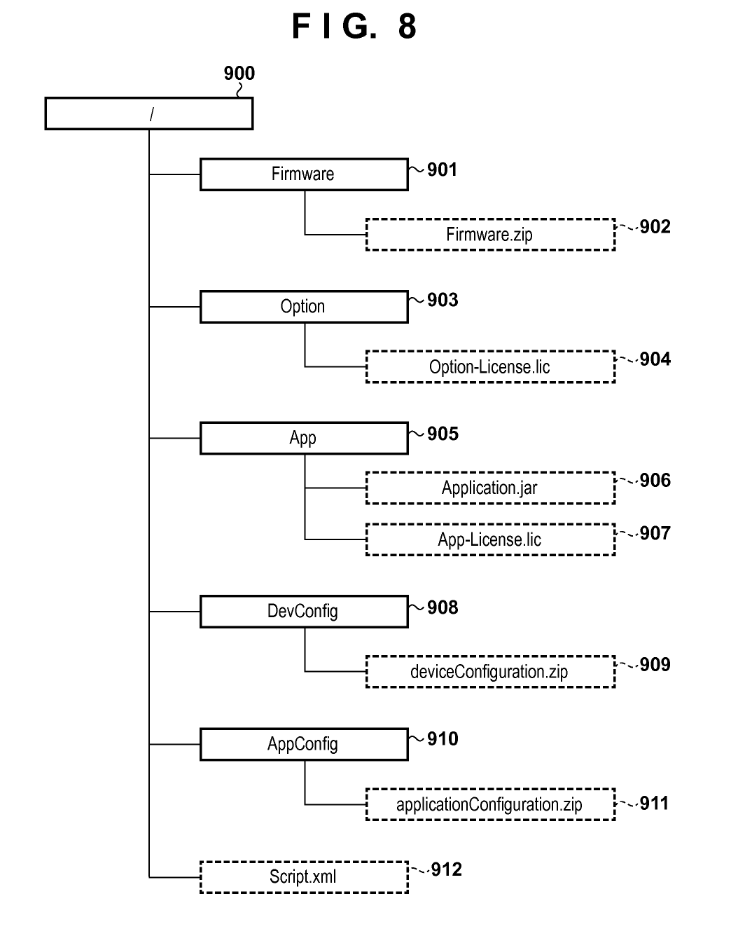

FIG. 8 is a diagram illustrating an example of a folder and a file structure within USB storage 209, used by the automatic installation program 700, according to the present invention.

A Firmware folder 901, an Option folder 903, an App folder 905, a DevConfig folder 908, an AppConfig folder 910, and a Script.xml file 912 are present in a root folder 900.

The Firmware folder 901 is a folder that holds firmware to be updated for the image forming apparatus 101. In FIG. 8, a Firmware.zip file 902, in which a firmware group is archived in zip format, is present within the Firmware folder 901.

The Option folder 903 is a folder that holds a license file for activating an optional function incorporated into the native program 601 in advance. In FIG. 8, a license file Option-License.lic 904 is present in the Option folder 903. Although only a single license file is present in FIG. 8, in the case where a plurality of optional functions are to be activated, a license file is present for each of the optional functions.

The App folder 905 is a folder that holds the expansion program 607 to be installed in the image forming apparatus 101 and a license file required to install the expansion program 607. In FIG. 8, an expansion program Application.jar 906 and a license file App-License.lic 907 are present in the App folder 905. Although only a single expansion program and the license file thereof are present in FIG. 8, in the case where a plurality of expansion programs are to be installed, the plurality of expansion programs and a plurality of license files corresponding to the programs are present. Meanwhile, the configuration may be such that the automatic installation program 700 is stored in the USB storage 209 as one of these expansion programs and the automatic installation program 700 is installed first when installing the image forming apparatus 101. Alternatively, in the case where the automatic installation program 700 is installed in the image forming apparatus 101 in advance, the automatic installation program is not necessary as an expansion program.

The DevConfig folder 908 is a folder that holds device configuration information related to the image forming apparatus as a whole. In FIG. 8, a file deviceConfiguration.zip 909 archived in zip format is present in the DevConfig folder 908. The configuration information set in the image forming apparatus 101 as a result of the automatic installation program 700 being executed is the device configuration information stored in the DevConfig folder 908, for example.

The AppConfig folder 910 is a folder that holds application configuration information related to the expansion program 607 provided by the Application.jar 906. In FIG. 8, a file applicationConfigration.zip 911 archived in zip format is present in the AppConfig folder 910. With respect to the application configuration information as well, in the case where a plurality of expansion programs are to be installed, a plurality of pieces of application configuration information corresponding thereto are present.

Script.xml 912 is a script in which is denoted a setup procedure for automatically processing setup operations. This script includes items that are interpreted and executed in accordance with the execution of the automatic installation program 700. Details of this script will be given later. Note that the configuration illustrated in FIG. 8 is merely an example, and any folder structure may be used instead as long as it is a structure that can be interpreted by the automatic installation program 700 in accordance with the script analysis unit 704.

Setting Procedure Using Script

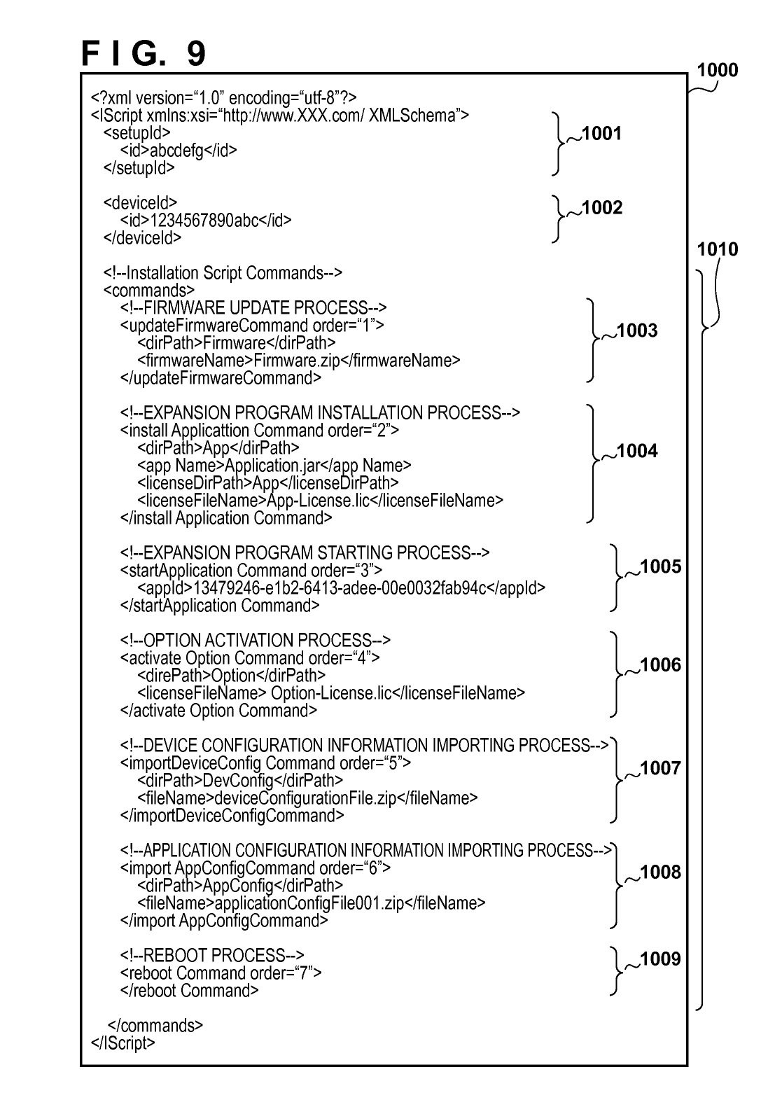

FIG. 9 illustrates an example of the script in which is denoted the setup procedure for automatically setting up the image forming apparatus 101. This script 1000 is held in the Script.xml 912 in the USB storage 209. Before the script is interpreted and executed, the automatic installation program 700 is first installed in the expansion program execution platform 602 as a expansion program of the image forming apparatus 101, and is then analyzed and executed by the automatic installation program 700. Accordingly, the script can be considered to be a type of program.

The script 1000 is read by the storage control unit 702 of the automatic installation program 700, and is analyzed by the script analysis unit 704 via the processing execution unit 703. After being analyzed by the script analysis unit 704, the processing denoted in the script 1000 is executed by the processing execution unit 703. The script 1000 illustrated in FIG. 9 is generated by the client computer 103. The script 1000 is written in XML (Extensible Markup Language), and is configured of a project data identification portion 1001, an image forming apparatus identification portion 1002, and a processing description portion 1010. Although the script is written in XML in FIG. 9, the script is not limited to XML, and may be written as a shell script or the like.

The project data identification portion 1001 is configured of a <setupId> in which a project ID for identifying the project data, described later, is written. The project ID is an identifier assigned to the project data when the project data is generated by the project management program 800, and is a value unique to each piece of project data. For example, a GUID (Globally Unique Identifier) is used as the project ID.

The image forming apparatus identification portion 1002 denotes a target identifier for identifying the image forming apparatus 101 that is to be set up (that is to be configured), and is configured of a <deviceId> that is an identifier of the image forming apparatus 101. For example, a combination of a product ID and a serial number can be employed as the target identifier.

The processing description portion 1010 denotes a group of processes necessary for the setup. In FIG. 9, the processing description portion 1010 is configured of a firmware update processing portion 1003, an expansion program installation processing portion 1004, an expansion program start processing portion 1005, an option activation processing portion 1006, a device configuration information import processing portion 1007, an application configuration information import processing portion 1008, and a reboot processing portion 1009. Order attributes are contained in tags indicating each process, and in FIG. 9, the order of the processes is determined based on the Order values. The firmware update processing portion 1003 is a process that updates the firmware via the firmware update service 603. The firmware update processing portion 1003 defines a process with an <updateFirmwareCommand> tag, and designates a file to be used through a <dirPath> tag and <firmwareName>. The <dirPath> tag denotes a relative path from the root folder 900 to the firmware to be used in the update. The <firmwareName> tag specifies the firmware to be used in the update. In FIG. 9, firmware archived in zip format is specified.

The expansion program installation processing portion 1004 defines a process with an <installApplicationCommand> tag, and specifies an expansion program to be installed using a <dirPath> tag and an <appName> tag. The <dirPath> tag denotes a relative path from the root folder 900 to the actual expansion program to be installed. The <appName> tag specifies the actual expansion program to be installed. In FIG. 9, an expansion program in the Jar file format is specified. Note, however, that the format of the expansion program is not limited to the Jar file format. However, with respect to the automatic installation program 700, the program is installed prior to the script being executed, and thus has a different installation method from the expansion program installation processing portion 1004.

Meanwhile, a license for the expansion program to be installed is specified by a <licenseDirPath> tag and a <licenseFileName> tag. The <licenseDirPath> tag denotes a relative path from the root folder 900 to the license file of the expansion program. The <licenseFileName> tag specifies the actual license for the expansion program. Although FIG. 9 indicates a license file in the .lic file format being specified, the license file format is not limited thereto.

The expansion program start processing portion 1005 defines a process with a <startApplicationCommand> tag, and specifies an expansion program to be started using an <appId> tag. The <appId> tag specifies an ID that uniquely identifies the expansion program to be started.

The option activation processing portion 1006 defines a process through the <activateOptionCommand> tag, and specifies a license file for an option to be activated through a <dirPath>tag and a <licenseFileName> tag. The <dirPath> tag denotes a relative path from the root folder 900 to the license file for the option to be activated. Although FIG. 9 indicates a license file in the .lic file format being specified, the license file format is not limited thereto. Note that it is not necessary to include this processing in the case where there are no optional functions incorporated into the image forming apparatus 101 in advance, or no optional functions are to be activated.

The device configuration information import processing portion 1007 defines a process through a <importDeviceConfigCommand> tag, and specifies a device configuration information file to be imported through a <dirPath> tag and a <fileName> tag. The <dirPath> tag denotes a relative path from the root folder 900 to the device configuration information file to be imported. The <fileName> tag specifies the device configuration information file to be imported. In FIG. 9, a device configuration information file archived in Zip format is specified. Note that the format of the device setting information file is not limited to the Zip file format. The device setting information file is a file that holds installation information set in the image forming apparatus.

The application configuration information import processing portion 1008 defines a process through an <importAppConigCommand> tag, and specifies an application configuration information file to be imported through a <dirPath> tag and a <fileName> tag. The <dirPath> tag denotes a relative path from the root folder 900 to the application configuration information file to be imported. The <configFileName> tag specifies the application configuration information file to be imported. In FIG. 9, an application configuration information file archived in Zip format is specified. Note that the format of the application configuration information file is not limited to the zip file format.

The reboot processing portion 1009 is configured only of a <rebootCommand> tag, and is a process for rebooting the image forming apparatus and applying settings to the image forming apparatus after the series of setup processing has ended.

Note that the content of the script indicated in FIG. 9 is not limited to the processing necessary to set up the image forming apparatus, and processes may be repeated, added, or removed as necessary.

Setup Operations

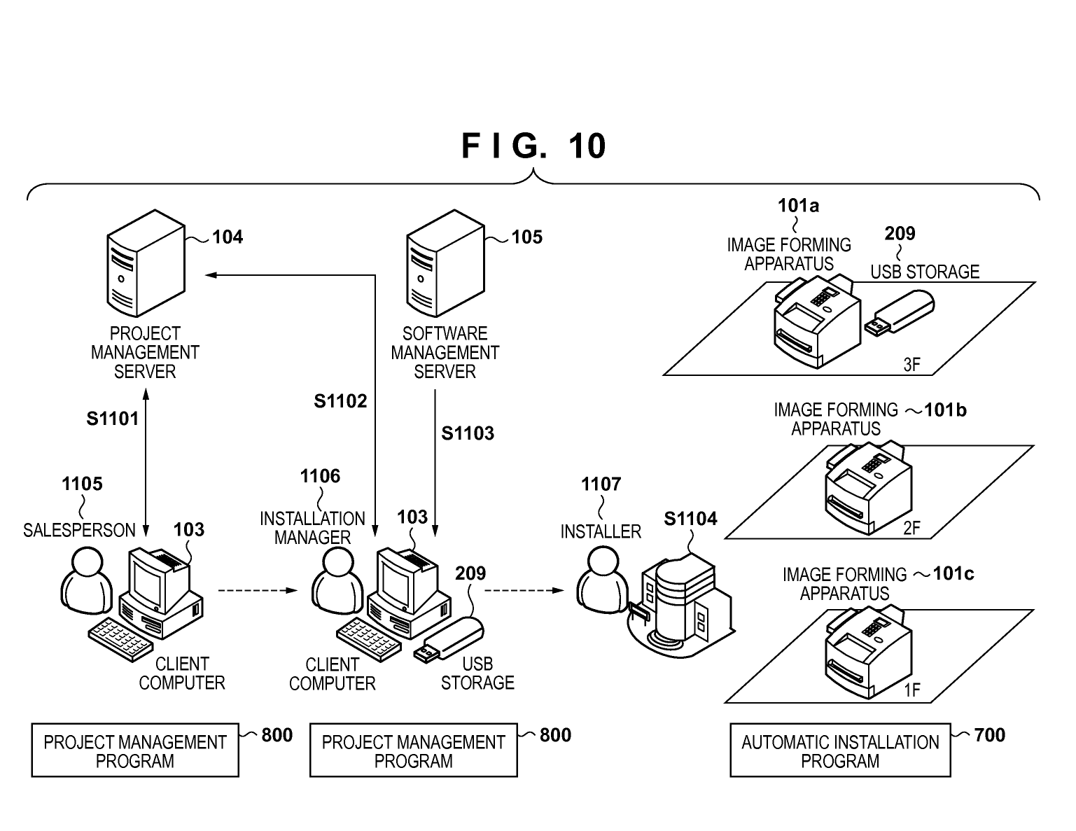

FIG. 10 is a workflow diagram illustrating a basic flow of setup operations for the image forming apparatus 101 according to the present invention.

Step S1101 is an operation carried out by a salesperson 1105 at each sales location. The salesperson 1105 consults with a customer and then inputs the configuration of an image forming apparatus that has been decided on, as well as setting details thereof, using the project management program 800 of the client computer 103. The configuration of the image forming apparatus is the model type, options to be activated, extension applications to be installed, and the like. The input details are sent to the project management server 104 as the project data and are managed by the project management server 104.

Step S1102 is an operation carried out by an installation manager 1106 at a warehouse or the like for managing the storage and retrieval of the image forming apparatus, and here, identifiers that enable each image forming apparatus to be specified (called “target identifiers” hereinafter) can be obtained. The installation manager 1106 obtains the project data of a project to be processed from the project management server 104 and edits the project data using the project management program 800 on the client computer 103. “Editing” here refers to registering the target identifier of the image forming apparatus to be set up in the project data. The project data in which the target identifier has been registered is again sent to the project management server 104 and managed in that server.

In step S1103, the installation manager 1106 uses the project management program 800 to generate a setup USB storage for setting up the image forming apparatus. The installation manager 1106 obtains the project data of the project to be processed from the project management server 104, and in accordance with the details of the project data obtains, from the software management server 105, configuration information such as the firmware, expansion applications, and so on necessary for the setup, as well as license files for installing the firmware, expansion applications, and the like. At this time, for licenses in a format in which there is a single license for a single image forming apparatus, the respective license files are obtained based on the target identifiers registered in step S1102. The project management program 800 generates the script 1000 based on project data and the obtained configuration information such as a software type, and saves the script 1000 along with the obtained configuration information such as the software type into the USB storage. Although step S1102 and step S1103 are described as separate steps, it is not particularly necessary to separate the two, and a procedure may be employed in which the software type is obtained when registering the target identifier and is saved into the USB storage.

Step S1104 is an operation carried out by an installer 1107 at customer sites where the image forming apparatuses will actually be set up. When the image forming apparatuses 101 and the USB storage 209 are shipped from the warehouse, the installer 1107 delivers the image forming apparatuses to respective locations requested by the customers. When the installer 1107 connects the USB storage 209 generated in step S1103 to the image forming apparatus 101, the automatic installation program 700 of the image forming apparatus 101 automatically executes the setup process, and the operation is complete.

Project Data Structure (1)

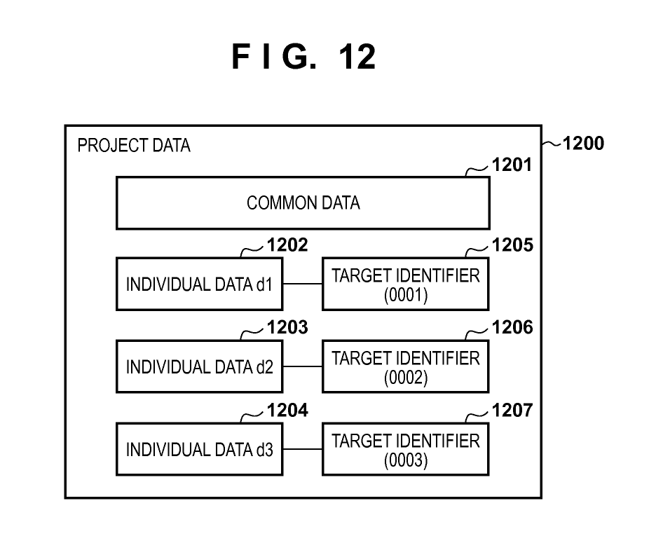

FIG. 12 is a diagram illustrating an example of the data structure of the project data generated by the project data management unit 804 of the project management program 800. Project data 1200 is configured of common data 1201, individual data 1202, 1203, and 1204, and target identifiers 1205, 1206, and 1207. FIG. 12 illustrates a data structure for a case where the project is for setting up three image forming apparatuses.

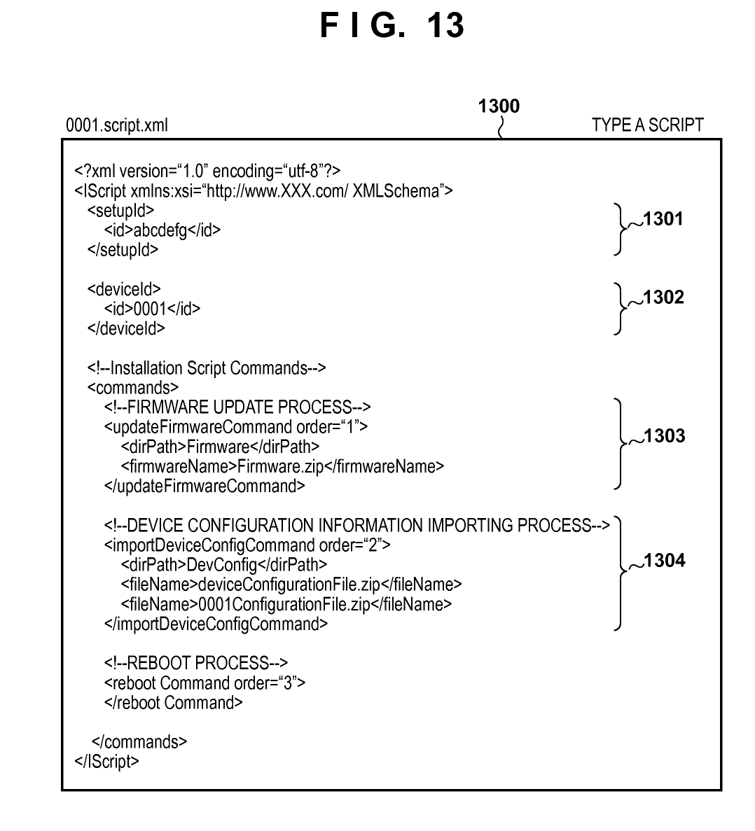

The common data 1201 is configuration data used in common for a plurality of image forming apparatuses (common configuration information), and the individual data 1202, 1203, and 1204 are configuration data having different configuration values for each of the image forming apparatuses (individual configuration information). The common data 1201 and the individual data 1202, 1203, and 1204 are input from the project management program 800 by the salesperson 1105 in step S1101 of FIG. 10. Furthermore, the target identifiers 1205, 1206, and 1207 are identifiers that enable the respective image forming apparatuses to be specified, and are input by the installation manager 1106 as additions to the project data 1200 in step S1102 of FIG. 10. In the case where the target identifier and the individual data can be associated in advance, it is possible to define in advance which image forming apparatus a given piece of individual data is to be applied, and thus a script such as that shown in FIG. 13 can be generated. Although not shown in the drawings, the project data also includes identification information (a setup ID) for identifying that data, which is, for example, written in the script, which will be described later, as a project data setup ID regarding the configuration information.

As indicated by the script 1000 in FIG. 9, a variety of commands can be executed in the setup process, but the following use case will be assumed in order to simplify the descriptions:

There are three image forming apparatuses to be set up.

The same version of firmware is installed in all three apparatuses.

Common device settings are imported into all three apparatuses.

Different values are imported into the three apparatuses for some of the items in the device settings.

Script Example (1)

FIG. 13 illustrates an example of a script for the above use case in the case where the target identifier and the individual data are associated in advance. A script 1300 is a script in which a target identifier 0001 is associated with an image forming apparatus, and a project ID, which is identification information for the project data, is written in a project data identification portion 1301. The target identifier 0001 is written in an image forming apparatus identification portion 1302. In the case of a script for an image forming apparatus having a target identifier 0002, 0002 is written in the image forming apparatus identification portion 1302. Meanwhile, in FIG. 13, the target identifier is used for the filename of the script, resulting in a name such as 0001script.xml; however, another configuration may be used as long as it enables the script to be identified as a script for a specific, unique image forming apparatus. Firmware.zip is written in a firmware update processing portion 1303, and deviceConfiguratonFile.zip is written in a device configuration information import processing portion 1304. These are configuration information filenames applied to all three image forming apparatuses, and are designated as the common data 1201 of the project data 1200. 0001ConfigurationFile.zip is also written as a <fileName> in the device configuration information import processing portion 1304. This is the filename of the individual data corresponding to the target identifier 0001, or in other words, of the configuration information applied to the individual image forming apparatus, and is generated from a value input as individual data d1 (1202) in the project data 1200. This filename becomes 0002ConfigurationFile.zip, for example, in the case of the individual data corresponding to the target identifier 0002, and the filename is defined for each script corresponding to each target identifier.

If the individual data and the target identifier are associated before FIG. 10 (step 1102 in the workflow), a script in which are written details specific to each image forming apparatus can be generated, as is the case of the script 1300 illustrated in FIG. 13. However, there are many cases where such association cannot be carried out in advance. For example, there are many cases where the floors on which the image forming apparatuses are to be installed have not been decided on in step S1104 of the workflow shown in FIG. 10. In other words, the installer 1107 installs any given image forming apparatus, from the image forming apparatuses that have been delivered, in a predetermined location, and then carries out a (individual) setup process specific to the installation location.

In such a case, incorrect settings may be applied if the individual data and a target identifier are associated in advance, and thus scripts specific to each image forming apparatus, in which the individual data of the image forming apparatus (that is, individual configuration information) is associated with the target identifier of that image forming apparatus (see FIG. 13), cannot be generated. As a result, in step 1104, it is not possible to connect the USB storage 209 to the image forming apparatuses 101(a) (b) (c) and automatically execute the setup process through the automatic installation program 700. A technique for solving this problem will be described in detail hereinafter.

Project Data Structure (2)

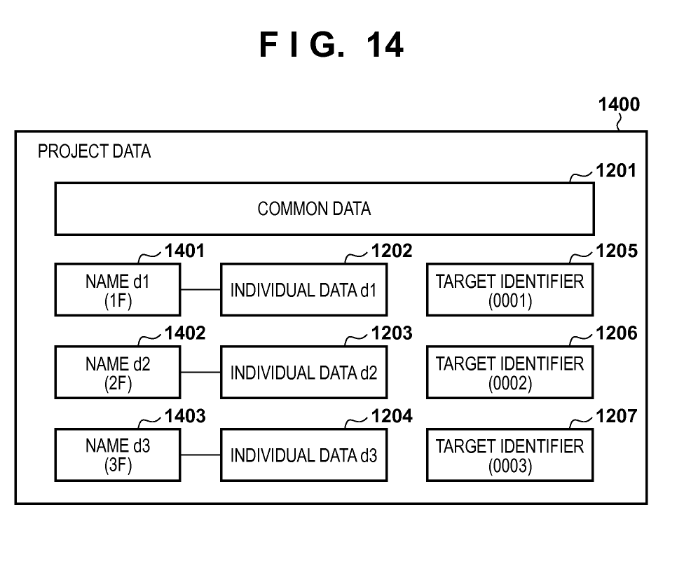

FIG. 14 is a diagram illustrating the data structure of the project data for solving this problem, in the case where the individual data and the target identifiers are not associated in advance. Project data 1400 is configured of the common data 1201, the individual data 1202, 1203, and 1204, and the target identifiers 1205, 1206, and 1207, as well as names 1401, 1402, and 1403 serving as identification names for identifying the individual data. FIG. 14 illustrates a data structure for a case where the project is for setting up three image forming apparatuses.

The difference between the project data 1200 shown in FIG. 12 and the project data 1400 shown in FIG. 14 is that the project data 1400 adds the names 1401, 1402, and 1403 to the project data 1200. Furthermore, although respective pieces of individual data are associated with respective target identifiers in the project data 1200, the project data 1400 has a characteristic difference in that the names, rather than the target identifiers, are associated with the individual data.

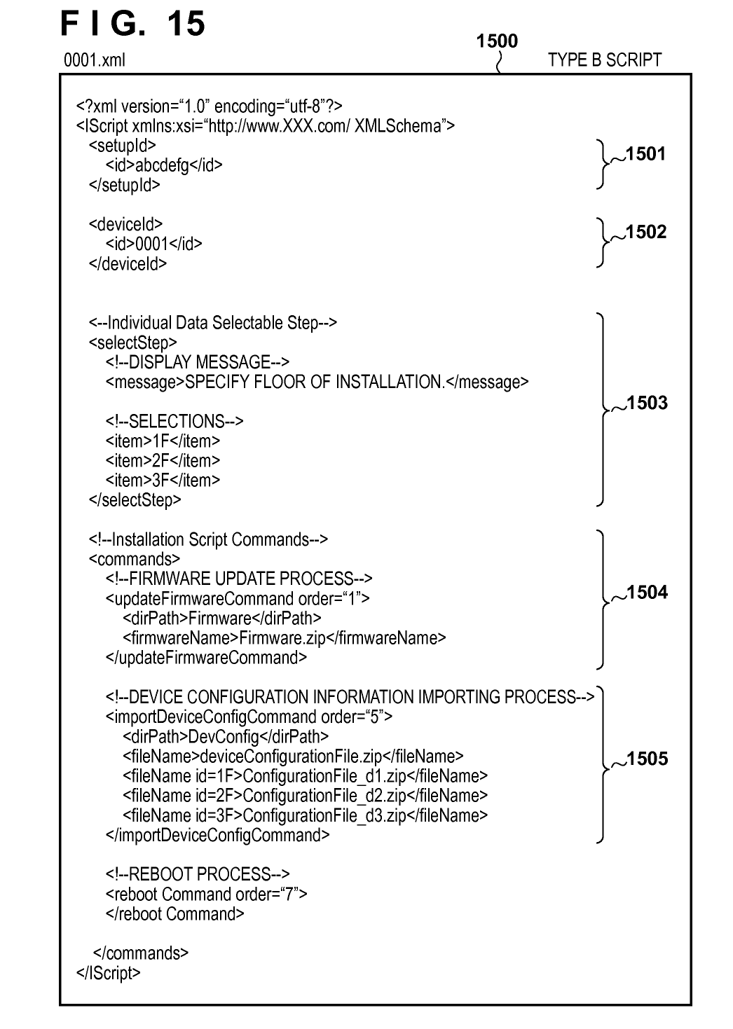

The common data 1201, the individual data 1202, 1203, and 1204, and the target identifiers 1205, 1206, and 1207 are the same as those illustrated in FIG. 12. The names 1401, 1402, and 1403 are input from the project management program 800 by the salesperson 1105 in step S1101 of the workflow in FIG. 10. The salesperson 1105 consults with the customer regarding the details of the individual data, and sets, for each piece of individual data, a name that enables characteristics of the individual data, the installation location of the image forming apparatus, a business department name, and so on to be recognized. Of course, as long as a name that enables the individual data to be distinguished can be set, the input operation is not limited to the salesperson 1105, and may be carried out by the installation manager 1106. Note that the project data shown in FIG. 14 includes the same type of project data identification information as that illustrated in FIG. 12, an individual data identification information is added to each piece of the individual data 1202 to 1204. Any information may be used as the individual data identification information as long as it is unique within the project data. Based on the project data illustrated in FIG. 14, the script generation unit 805 in the project management program 800 generates a script such as that illustrated in FIG. 15. The same use case as that described with respect to the script illustrated in FIG. 13 is assumed here.

Script Example (2)

FIG. 15 is a diagram illustrating the configuration of a script generated based on the project data 1400, in the case where the aforementioned use case is assumed in the individual data and target identifiers are not associated in advance. A script 1500 is a script corresponding to the image forming apparatus having the target identifier 0001, where the project ID is written in a project data identification portion 1501 and the target identifier 0001 is written in an image forming apparatus identification portion 1502. In the case of a script for the image forming apparatus having the target identifier 0002, 0002 is written in the image forming apparatus identification portion 1502. This point is the same as with the script 1300 in FIG. 13, and the filename of the script also uses a target identifier, for 0001.xml. Likewise, in the same manner as in the script 1300 illustrated in FIG. 13, the filename is written into a firmware update processing portion 1504 as well in the scripts corresponding to all of the image forming apparatuses.

The differences from the script 1300 illustrated in FIG. 13 are that an individual data selection processing portion 1503 has been added, and information regarding the individual data of all of the image forming apparatuses expected to be installed is written in a device configuration information import processing portion 1505. The individual data selection processing portion 1503 is configured of a display message and selections. Although this embodiment assumes a configuration in which any given message can be registered as the display message by the project management program 800, the configuration may be such that a fixed message is held within the automatic installation program 700 and is not written in the script 1500. The device configuration information import processing portion 1505 includes a part that sets common data (this can also be called a common setting command) and a part that sets individual data for each image forming apparatus (this can also be called an individual setting command).

Values input as the names 1401, 1402, and 1403 of the project data 1400 are written in the selection part. In the present embodiment, “1F” is input as the name 1401, “2F” is input as the name 1402, and “3F” is input as the name 1403.

A device configuration information file deviceConfigurationFile.zip imported as common data for all of the image forming apparatuses is written in the device configuration information import processing portion 1505, as are device configuration information files ConfigurationFile_d1.zip, ConfigurationFile_d2.zip, and ConfigurationFile_d3.zip, which are imported as individual data. Meanwhile, an id attribute for identifying the individual data is added to the <fileName> tags thereof as an attribute. Due to the presence of the id attribute, the automatic installation program 700 can recognize that the content is for individual data rather than for common data. The value of an <item> designated by the individual data selection processing portion 1503 is set in the id attribute, clarifying a correspondence relationship between the individual data and the name. Of course, a configuration in which the <item> value is not set for the id attribute may be employed as long as the automatic installation program 700 is capable of recognizing the correspondence relationship between the individual data and the name.

Normally, if the individual data and the target identifiers can be associated in advance, or in other words, if individual configuration information can be specified in advance, it is only necessary to provide the information of the individual data corresponding to the respective target identifier. However, because such an association cannot be made in advance, information regarding all of the pieces of individual data is written in the device configuration information import portion of the script, as is the case with this script. In other words, aside from the image forming apparatus identification portion 1502, the same content is written in a script 0001.xml (a script for the target identifier 0001), a script 0002.xml (a script for the target identifier 0002), and a script 0003.xml (a script for the target identifier 0003).

Script Generation Process

FIG. 16 is a flowchart illustrating the flow of a process carried out when the project management program 800 writes setup data into the USB storage 209. Upon receiving a USB write instruction from the UI control unit 801 (S1601), the processing execution unit 802 of the project management program 800 calls the project data management unit 804 and obtains the project data of the instructed project from the project management server 104 (S1602). The project data is data configured as illustrated in FIG. 12, FIG. 14, or the like. The processing execution unit 802 analyzes the obtained project data and checks whether or not a target identifier is registered in the project data (S1603).

In the case where not even one target identifier is registered, the script generation unit 805 cannot generate a script corresponding to a respective target identifier, and thus in step S1604, the processing execution unit 802 cancels the process for writing into the USB storage 209. The project data generated at step S1101 of the workflow illustrated in FIG. 10 corresponds to this case. Although the salesperson 1105 can input the information necessary for setting up the image forming apparatus 101, the actual image forming apparatus is not in his/her possession and thus the target identifier cannot be input.

In the case where even one target identifier is registered, in step S1605, the processing execution unit 802 obtains, from the software management server 105, the software types (firmware, license files, and so on, for example) necessary for the setup, based on the project data. When the process of downloading the software ends, the processing execution unit 802 calls the script generation unit 805.

In step S1606, the script generation unit 805 checks whether or not individual data is registered in the project data. In the case where not even one piece of individual data is registered, the script generation unit 805 generates a type A′ script (S1607). A state in which not even one piece of individual data is registered is a state in which the individual data 1202, 1203, and 1204 are not present in the project data 1200 illustrated in FIG. 12, and indicates project data configured only of the common data 1201 and the target identifiers 1205, 1206, and 1207. The individual data not being registered means that all of the image forming apparatuses will be set up according to the same details; in other words, this means that scripts having the same details will be executed for all of the image forming apparatuses to be set up.

The type A′ script generated from the stated project data in which no individual data is registered corresponds to a script in which the information <fileName>0001ConfigurationFile.zip</fileName> regarding the individual data is absent from the device configuration information import processing portion 1304 in the script 1300 illustrated in FIG. 13. Of course, the script generation unit 805 writes the target identifiers of the image forming apparatuses to be set up in the image forming apparatus identification portion 1302, and generates three scripts, namely 0001script.xml, 0002script.xml, and 0003script.xml.

When the script generation unit 805 generates the scripts corresponding to respective target identifiers, the processing execution unit 802 calls the storage control unit 803, and saves all of the scripts along with the software downloaded in step S1605 into the USB storage 209 (S1608). In step S1606, when the script generation unit 805 detects that individual data is registered, the script generation unit 805 furthermore checks whether or not target identifiers are associated with that individual data in step S1609.

In the case where target identifiers are associated with all of the pieces of individual data, the script generation unit 805 generates a type A script (S1610). The project data at this time has the configuration of the project data 1200 illustrated in FIG. 12. Furthermore, the type A script generated from that project data has the configuration of the script 1300 illustrated in FIG. 13. In other words, the respective target identifiers are recorded in the image forming apparatus identification portion 1302, the common data deviceConfigurationFile.zip is recorded in the device configuration information import processing portion 1304, and one of an individual data 0001ConfigurationFile.zip, 0002ConfigurationFile.zip, and 0003ConfigurationFile.zip is recorded based on the corresponding target identifier. The image forming apparatus identification portion 1302 and the individual data parts of the configuration information import processing portion 1304 thus have specific values based on the target identifiers of the image forming apparatuses to be set up. When the script generation unit 805 generates the scripts corresponding to respective target identifiers, the processing execution unit 802 calls the storage control unit 803, and saves all of the scripts into the USB storage 209 (S1608).

On the other hand, in step S1609, in the case where no target identifier is associated with any of the pieces of the individual data, the script generation unit 805 generates a type B script (S1611). A state in which individual data is registered in the project data but no target identifiers are associated corresponds to the configuration of the project data 1400 illustrated in FIG. 14. The individual data and target identifiers are registered, but the individual data and the target identifiers are not associated, and the names 1401, 1402, and 1403 are associated with the individual data 1202, 1203, and 1204 instead of target identifiers. Such project data being generated by the project data management unit 804 means that different settings are to be applied to each image forming apparatus, but for some reason the target identifiers cannot be specified until the image forming apparatuses are actually installed at the customer site and the individual data and target identifiers could therefore not be associated in advance. Accordingly, the salesperson 1105 uses the project management program 800 to set the respective names 1401, 1402, and 1403 for the respective pieces of individual data, making it possible to distinguish the pieces of individual data.

The type B script generated from such project data has the configuration of the script 1500 illustrated in FIG. 15. The script generation unit 805 writes the individual data selection processing portion 1503 in accordance with the names registered in the project data. Meanwhile, information regarding all of the pieces of individual data associated with the names is written in the device configuration information import processing portion 1505. Then, in step S1611, scripts having the same details aside from the image forming apparatus identification portion 1502 and the script filenames are generated for each of the apparatuses to be set up.

When the script generation unit 805 generates the scripts corresponding to respective target identifiers, the processing execution unit 802 calls the storage control unit 803, and saves all of the scripts along with the software downloaded in step S1605 into the USB storage 209 (S1608).

In the case where the script generation unit 805 has detected that target identifiers are associated only with some of the pieces of registered individual data in step S1609, two types of scripts, namely the type A and the type B, are generated in step S1612. The type A is generated as a script corresponding to project data in which target identifiers are associated with the individual data, whereas the type B is generated as a script corresponding to project data in which names are associated with the individual data instead of target identifiers.

When the script generation unit 805 generates the scripts corresponding to respective target identifiers, the processing execution unit 802 calls the storage control unit 803, and saves all of the scripts along with the software downloaded in step S1605 into the USB storage 209 (S1608).

Script Execution Process

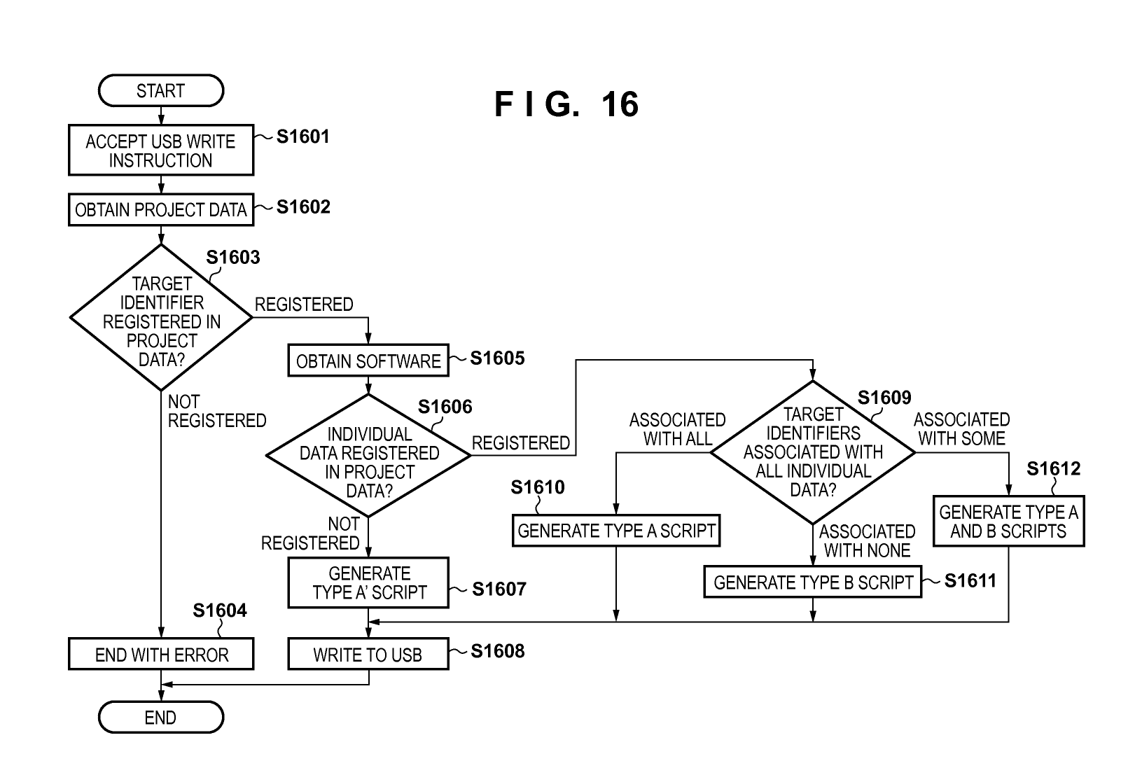

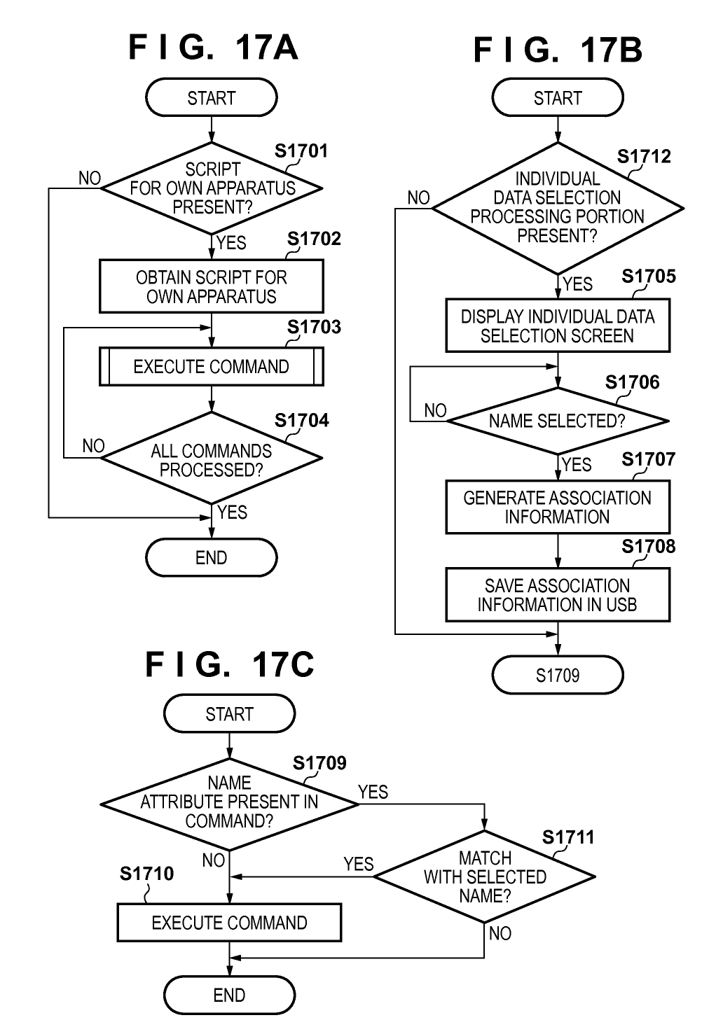

FIG. 17A illustrates a basic flow carried out when the automatic installation program 700 executes a script. When the USB storage 209 is connected to the image forming apparatus 101 by the installer 1107 and the connection is detected by the storage control unit 702, the execution of the automatic installation program 700 starts.

In step S1701, the processing execution unit 703 checks whether or not a script for its own apparatus is present in the USB storage. A condition for determining that a script for its own apparatus is present is the target identifier of its own apparatus being included in the filename of an XML file immediately below the root folder 900 in the USB storage 209. Although the configuration in the present embodiment is such that the script of its own apparatus is detected based on the filename, another configuration may be employed instead. For example, the configuration may be such that the files immediately below the root folder 900 in the USB storage 209 are read sequentially and the <deviceId> in the image forming apparatus identification portion 1502 is checked.

In the case where a script corresponding to the target identifier of its own apparatus is not present, the processing execution unit 703 takes no particular action. Alternatively, an error message prompting the correct USB storage to be connected is displayed, after which the processing ends.

In the case where a script corresponding to the target identifier of its own apparatus is present, the processing execution unit 703 loads and saves the script into the HDD 207 of the image forming apparatus 101 (S1702).

In step S1703, the processing execution unit 703 calls the script analysis unit 704, whereupon the script saved in HDD 207 is analyzed and various types of commands are executed based on a result of the analysis. Details of step S1703 will be described using FIG. 17B.

When a command is executed, in step S1704, the script analysis unit 704 checks whether or not all of the commands in the script have been executed. In the case where the processes of all commands are complete, the processing ends. In the case where a command that has not yet been executed remains, the processing returns to step S1703, and the next command is executed.

FIG. 17B is a flowchart illustrating a flow of processing performed when the script 1500 executes the individual data selection processing portion 1503 in the command execution step S1703 of FIG. 17A.

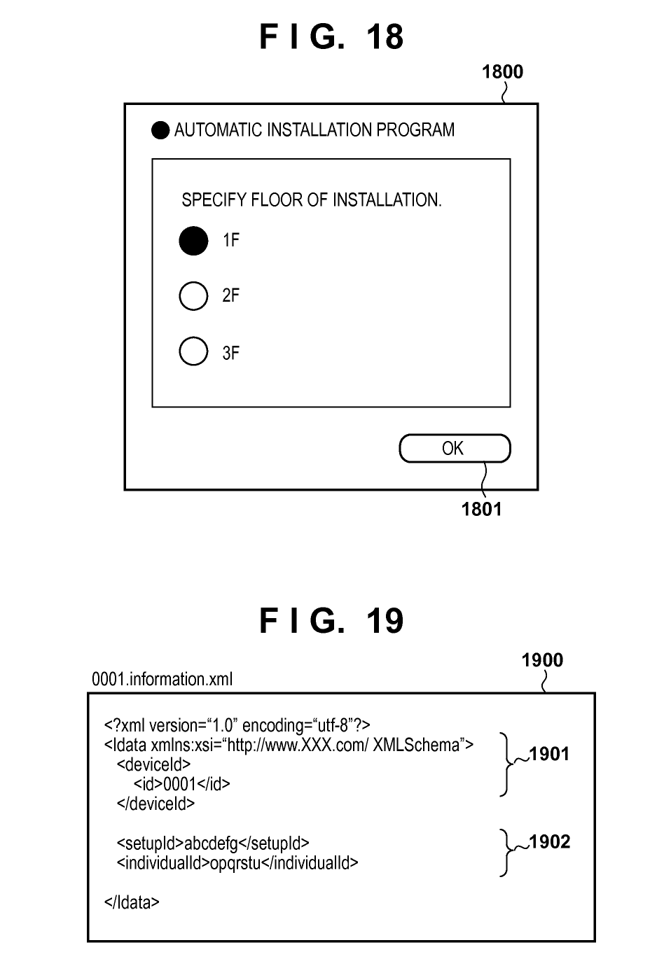

First, it is determined whether the obtained script is present in the individual data selection processing portion 1503 (S1712). The process branches to step S1709 of FIG. 17C in the case where the script is not present. On the other hand, in the case where the script analysis unit 704 detects the individual data selection processing portion 1503 based on the script, the processing execution unit 703 instructs the UI control unit 701 to display an individual data selection screen, such as that shown in FIG. 18, in step S1705. A message and respective names serving as selections, written in the individual data selection processing portion 1503, are displayed in an individual data selection screen 1800.

In step S1706, the UI control unit 701 stands by until it is detected that the installer 1107 has selected a piece of individual data and pressed an OK button 1801. When the UI control unit 701 detects that the OK button 1801 has been pressed, in step S1707, the processing execution unit 703 generates association information between the target identifier of its own apparatus and the individual data associated with the selected name. The association between the selected name in the individual data can be obtained by referring to the device configuration information import processing portion 1505. The association information indicates a correspondence relationship between the target identifier and the individual data, and any format may be used for this information as long as the information can be interpreted by the project management program 800, the project management server 104, and so on. In the present embodiment, it is assumed that this information is generated as XML, by the script analysis unit 704 called by the processing execution unit 703, and that the information has a structure such as that shown in FIG. 19.

Association information 1900 is configured of an image forming apparatus identification portion 1901 and an individual data identification portion 1902. The target identifier of the own apparatus that has been set up is recorded in the image forming apparatus identification portion 1901. The project ID <setupId> for identifying the project data used in the set up and an individual ID <individualId> that enables the individual data to be identified are recorded in the individual data identification portion 1902. This individual ID is added to each piece of individual data when the project management program 800 generates the project data 1200, 1400, or the like, and a unique value is assigned to each piece of individual data. For example, a GUID (Globally Unique Identifier) is used as the project ID. Using the target identifier of its own apparatus, the script analysis unit 704 generates the association information 1900 with a name such as 0001information.xml. Although the present embodiment assumes a configuration in which the individual ID is written in the association information, the configuration may be such that a name is written instead of the individual ID. The name is written in the individual data selection processing portion 1503 of the script 1500. The value selected by the installer 1107 may be written in the association information.

FIG. 17C is a flowchart illustrating a flow of processing when a normal setup processing portion (the processes after the individual data selection processing portion 1503 of the script 1500) is executed in the command execution step S1703 of FIG. 17A. The processing illustrated in FIG. 17C is carried out after step S1708 of FIG. 17B.

In step S1709, the script analysis unit 704 identifies whether or not a name attribute has been added to the command that has been read. The “name attribute” corresponds to a part “id=1F” of the device configuration information import processing portion 1505 mentioned in the descriptions of the script 1500 illustrated in FIG. 15.

In the case where the script analysis unit 704 has not detected the name attribute, the processing execution unit 703 executes the command in step S1710. On the other hand, in the case where the script analysis unit 704 has detected the name attribute, in step S1711, it is further checked whether or not that attribute value matches the name selected by the installer 1107 in step S1706. In the case where the names match, the processing execution unit 703 executes the command in step S1710, whereas in the case where the names do not match, the command is not processed.

By adding a name to the individual data in this manner, the correct processing can be carried out even if a command that handles individual data unrelated to its own apparatus is written, as with the device configuration information import processing portion of the script 1500.

Post-Processing after Automatic Installation Process

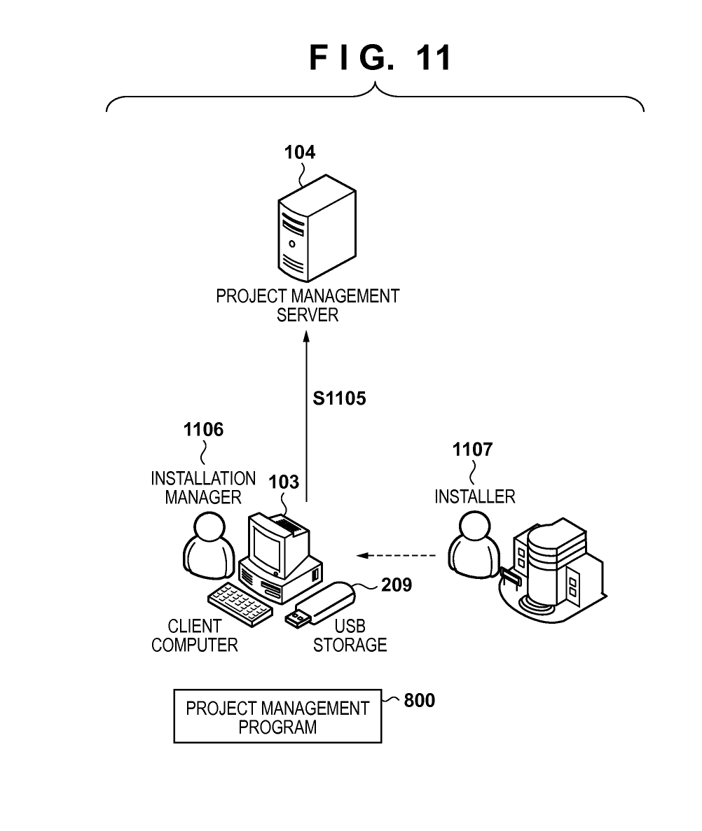

FIG. 11 is a workflow diagram illustrating a flow of operations after the image forming apparatus 101 has been set up, according to the present invention. When the image forming apparatus 101 is set up in step S1104 of FIG. 10, the processing execution unit 703 of the automatic installation program 700 records the association information 1900 into the USB storage 209 in step S1708 of FIG. 17B. In FIG. 11, the installer 1107 returns the USB storage 209 that contains the association information 1900 to the installation manager 1106. In step S1105, the installation manager 1106 connects the returned USB storage 209 to the client computer 103, executes the project management program 800, reads the association information, and uploads the updated project data to the project management server 104.

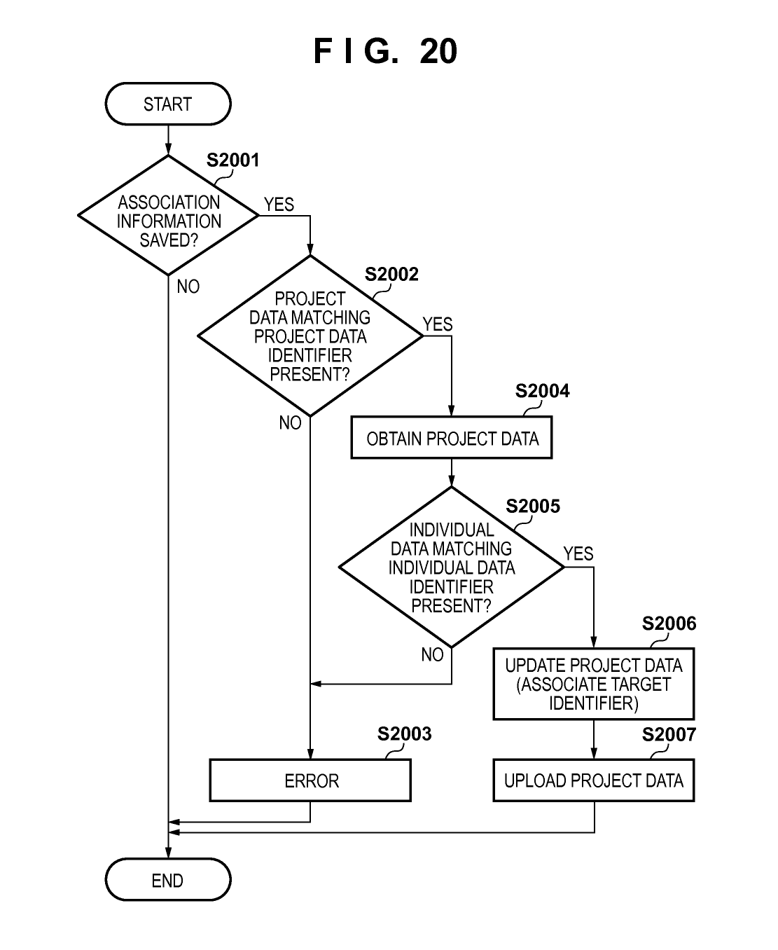

FIG. 20 is a flowchart illustrating a flow of processing performed by the project management program 800 in step S1105 of FIG. 11. The installation manager 1106 connects the USB storage 209 to the client computer 103, and makes an input instructing the association information to be updated for the project data. When the UI control unit 801 receives the association information update instruction from the installation manager 1106, in step S2001, the processing execution unit 802 checks whether or not an association information file 1900 is present in the USB storage 209. In the case where the association information file 1900 is not present despite the association information update instruction having been received, the processing execution unit 802 displays a message to that effect via the UI control unit 801, and ends the processing.

In the case where the association information file is saved, the processing execution unit 802 copies the association information file into the HDD 304. Then, in step S2002, the processing execution unit 802 sends, to the project management server 104 via the network I/F 308, a request to obtain project data that matches a project ID (abcdefg, in the example shown in FIG. 19) written in the association information file. In the case where the data cannot be obtained, in step S2003, the processing execution unit 802 displays an error message indicating that the project data is not present via the UI control unit 801, and ends the processing.

In the case where the project data is present in step S2002, the processing execution unit 802 saves the obtained project data in the HDD 304. In step S2005, the processing execution unit 802 calls the project data management unit 804, and checks whether or not individual data that matches the individual ID (or name) read out from the association information file by the script generation unit 805 is registered in the obtained project data.

In the case where individual data that matches the individual ID (or name) is not registered, in step S2003, the processing execution unit 802 displays, via the UI control unit 801, an error message indicating that the project data may have been updated, and ends the processing. In the case where individual data that matches the individual ID (or name) is registered, the project data management unit 804 associates the target identifier of the association information file 1900 (0001, in the example illustrated in FIG. 19) with that individual data, and updates the project data (S2006). In step S2007, the processing execution unit 802 uploads, to the project management server 104 via the network I/F 308, the project data updated in step S2006.

Through this processing, for example, in the project data 1400 illustrated in FIG. 14, the individual data 1202 and the target identifier 1205 are associated with each other. When the individual data and the target identifier are associated, the script generated for the image forming apparatus corresponding to that target identifier is generated having a configuration such as the type A script 1300, or in other words, in a format in which the target identifier and individual data are associated with each other. Accordingly, updating the configuration information, installing external applications, turning optional functions on or off, and so on after the installation has been completed can be specified by executing the script, without selecting the names.

### Second Embodiment

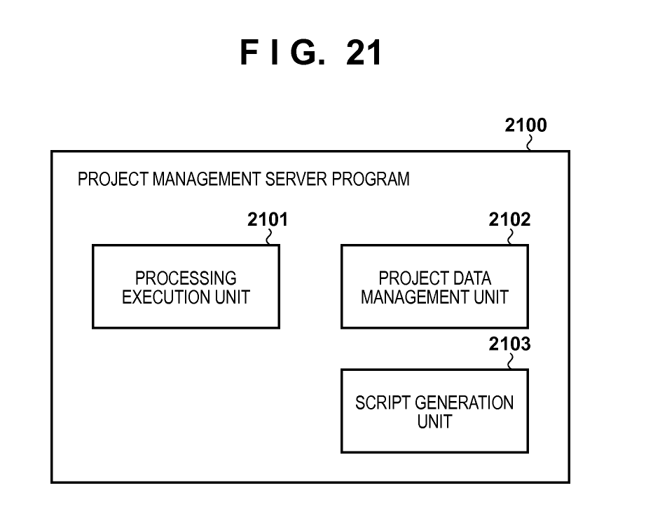

Although the first embodiment describes a configuration in which the function 805 for generating the script from the project data is provided in the project management program 800 in the client computer 103, the configuration may be such that the function is provided in the project management server 104. FIG. 21 is a diagram illustrating an example of the functional configuration of a project management server program 2100 that runs on the project management server 104. The CPU 401 realizes the respective functions by executing programs. The project management server program 2100 includes a processing execution unit 2101, a project data management unit 2102, and a script generation unit 2103. The processing execution unit 2101 carries out various types of processes in response to a request from the client computer 103 sent via the network I/F 405. The project data management unit 2102 stores project data sent from the client computer 103 in the HDD 404, generates a list of project data stored in the HDD 404, and so on. The script generation unit 2103 generates scripts that can be analyzed by the automatic installation program 700 based on the project data managed by the project data management unit 2102, in accordance with instructions from the processing execution unit 2101.

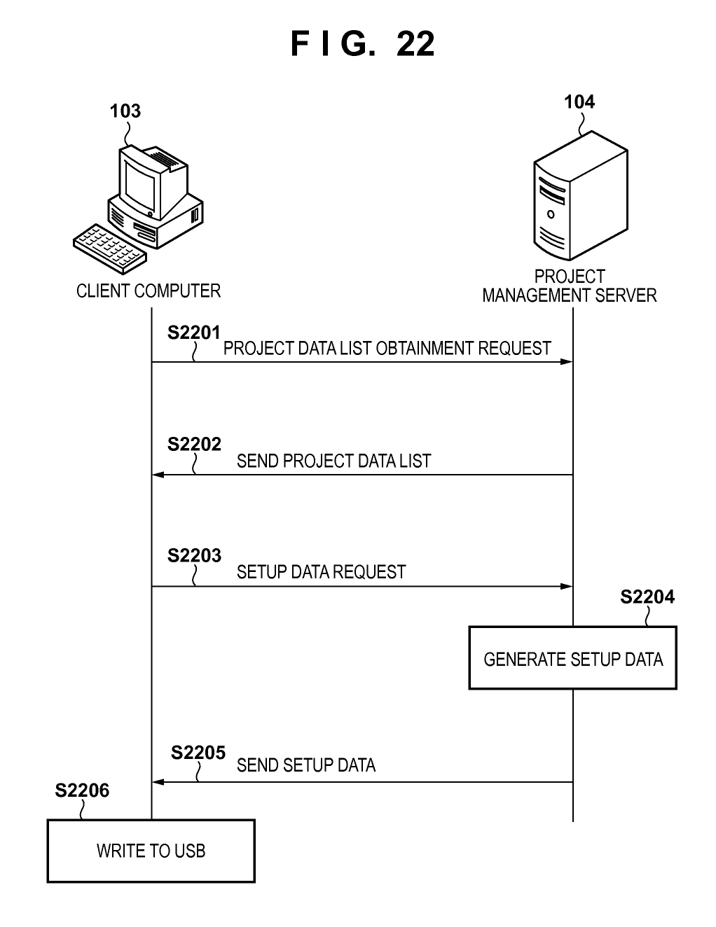

FIG. 22 is a sequence chart illustrating interactions between the client computer 103 and the project management server 104 in the case where the script generation unit 805 is provided in the project management server 104. The processing execution unit 802 of the project management program 800 sends, in response to an instruction from the UI control unit 801, a request for a list of project data from the project management server 104 (S2201). The processing execution unit 2101 of the project management server program 2100 calls the project data management unit 2102 in response to the request from the client computer 103, and sends the list of project data saved in the HDD 404 (S2202). The processing execution unit 802 of the project management program 800 displays the received project data list in a display via the UI control unit 801.

When a specific piece of project data is specified through the UI control unit 801 in accordance with a user selection, the processing execution unit 802 sends the project ID of the specified project data along with a setup data generation request to the project management server 104 (S2203). Having received the setup data generation request, the processing execution unit 2101 of the project management server program 2100 calls the script generation unit 2103, and executes the same processing as indicated by steps S1605 to S1607 and steps S1609 to S1612 illustrated in FIG. 16 (S2204). The processing execution unit 2101 of the project management server program 2100 sends the software obtained in step S1605 and the script generated in the following steps to the client computer 103 as setup data (S2205). Having received the setup data, the processing execution unit 802 of the client computer 103 calls the storage control unit 803 and saves the setup data in the USB storage 209 (S2206).

Through the procedure described above, the script executed by the automatic installation program for setting the configuration information of the image forming apparatus can be generated by the project management server 104.

### Other Embodiments

Note that project data in which the configuration information is not divided into common data and individual data, such as project data in which configuration data is provided for each image forming apparatus, can be handled as follows. That is, configuration items for which different values can be set from image forming apparatus to image forming apparatus are determined in advance. The set values for the configuration items determined in advance are then compared between pieces of project data, and if there is an item for which different values are set, the values set for that item are automatically extracted as items that enable the individual data to be identified, and the individual data is then classified for each image forming apparatus. Items for which different values cannot be set and items for which different values are not set serve as the common data 1201. Based on the project data 1200 reconfigured in this manner, the script is then generated according to the aforementioned configurations and procedures and executed.

Alternatively, in such a case, if the configuration information included in the project data is all defined as individual data and it is assumed that there is substantially no common data, the script can be created through the aforementioned configurations and procedures, and the automatic installation can be carried out according to that script.

Embodiments of the present invention can also be realized by a computer of a system or apparatus that reads out and executes computer executable instructions (e. g., one or more programs) recorded on a storage medium (which may also be referred to more fully as a ‘non-transitory computer-readable storage medium’) to perform the functions of one or more of the above-described embodiments and/or that includes one or more circuits (e. g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e. g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-050535, filed Mar. 13, 2014, which is hereby incorporated by reference herein in its entirety.

What is claimed is:

1. An automatic installation system comprising an information processing apparatus that generates a program for setting configuration information in one or more newly-installed image forming apparatuses and at least one image forming apparatus in which the configuration information is set by executing the generated program, the information processing apparatus including:
an obtaining unit that obtains the configuration information to be set in an image forming apparatus to be configured;
a generating unit that, in the case where the obtained configuration information includes individual configuration information set individually in the image forming apparatus to be configured and the individual configuration information is associated with an identifier of the individual configuration information, generates a first individual setting command for setting the individual configuration information in association with an input identifier when setting the configuration information in the image forming apparatus; and
a storing unit that stores a program including the generated first individual setting command and the individual configuration information in a medium, and
each of the at least one image forming apparatus loading the program, and including:
an input unit that accepts an input of the identifier in the case where the first individual setting command is included; and
a setting unit that sets the individual configuration information associated with the input identifier as the configuration information of the image forming apparatus.

2. The automatic installation system according to claim 1,
wherein the generating unit further generates choices including the identifier of the individual configuration information for each of the image forming apparatuses to be configured, and the storing unit stores the choices as part of the program; and
the input unit displays a user interface including the choices, and accepts the input of a single identifier selected from among the choices as the identifier.

3. The automatic installation system according to claim 1,
wherein in the case where the obtained configuration information includes common configuration information set in common for the image forming apparatus to be configured, the generating unit generates a common setting command for configuring all of the image forming apparatuses to be configured;
the storing unit further stores the program further including the generated common setting command and the individual configuration information in the medium; and
the setting unit further sets the common configuration information as the configuration information for the image forming apparatus in the case where the common setting command is included.

4. The automatic installation system according to claim 1,
wherein in the case where the obtained configuration information includes the individual configuration information and the individual configuration information is associated with the identifier of the image forming apparatus, the generating unit generates a second individual setting command for setting the individual configuration information associated with the identifier in the image forming apparatus having that identifier;
the storing unit further stores the program further including the generated second individual setting command and the individual configuration information in the medium; and
in the case where the second individual setting command is included, the setting unit further sets the individual configuration information associated with the identifier of the image forming apparatus as the configuration information of that image forming apparatus.

5. The automatic installation system according to claim 1,
wherein each of the one or more image forming apparatuses further includes a unit that generates, for each image forming apparatus to be configured, association information that associates an identifier of the image forming apparatus with an identifier of the set configuration information; and
the storing unit further stores the association information in the medium.

6. The automatic installation system according to claim 1,
wherein the information processing apparatus further includes a unit that, in the case where there are a plurality of image forming apparatuses to be configured, compares the configuration information set for each image forming apparatus, and classifies configuration information common to all of the image forming apparatuses as the common configuration information and configuration information that is not common as the individual configuration information.

7. A method for an automatic installation system that includes an information processing apparatus that generates a program for setting configuration information in one or more newly-installed image forming apparatuses and an image forming apparatus in which the configuration information is set by executing the generated program, the method comprising:
an obtaining step of the information processing apparatus obtaining configuration information to be set in an image forming apparatus to be configured;
a generating step of, in the case where the obtained configuration information includes individual configuration information set individually in the image forming apparatus to be configured and the individual configuration information is associated with an identifier of the individual configuration information, the information processing apparatus generating a first individual setting command for setting the individual configuration information in association with an input identifier when setting the configuration information in the image forming apparatus;
a storing step of the information processing apparatus storing a program including the generated first individual setting command and the individual configuration information in a medium, and
a step of each of the one or more image forming apparatuses loading the program and, in the case where the first individual setting command is included, accepting the input of the identifier, and setting the individual configuration information associated with the input identifier as the configuration information of the image forming apparatus.

8. An information processing apparatus that generates a program for setting configuration information in one or more newly-installed image forming apparatuses in which configuration information is set by executing a generated program, the apparatus comprising:
an obtaining unit that obtains the configuration information to be set in an image forming apparatus to be configured;
a generating unit that, in the case where the obtained configuration information includes individual configuration information set individually in the image forming apparatus to be configured and the individual configuration information is associated with an identifier of the individual configuration information, generates a first individual setting command for setting the individual configuration information in association with an input identifier when setting the configuration information in the image forming apparatus; and
a storing unit that stores a program including the generated first individual setting command and the individual configuration information in a medium.

9. The information processing apparatus according to claim 8,
wherein the generating unit further generates choices including the identifier of the individual configuration information for each of the image forming apparatuses to be configured, and the storing unit stores the choices as part of the program.

10. The information processing apparatus according to claim 8,
wherein in the case where the obtained configuration information includes common configuration information set in common for the image forming apparatus to be configured, the generating unit generates a common setting command for configuring all of the image forming apparatuses to be configured; and
the storing unit further stores the program further including the generated common setting command and the individual configuration information in the medium.

11. The information processing apparatus according to claim 8,
wherein in the case where the obtained configuration information includes the individual configuration information and the individual configuration information is associated with the identifier of the image forming apparatus, the generating unit generates a second individual setting command for setting the individual configuration information associated with the identifier in the image forming apparatus having that identifier; and
the storing unit further stores the program further including the generated second individual setting command and the individual configuration information in the medium.

12. The information processing apparatus according to claim 8, further comprising:
a unit that, in the case where there are a plurality of image forming apparatuses to be configured, compares the configuration information set for each image forming apparatus, and classifies configuration information common to all of the image forming apparatuses as the common configuration information and configuration information that is not common as the individual configuration information.

13. An image forming apparatus that sets configuration information by executing a program for setting the configuration information in one or more newly-installed image forming apparatuses, the image forming apparatus comprising:
an input unit that, in the case where the program is loaded and a first individual setting command for setting the individual configuration information associated with an identifier input when the configuration information is set in the image forming apparatus is included, accepts an input of the identifier; and
a setting unit that sets the individual configuration information associated with the input identifier as the configuration information of the image forming apparatus.

14. The image forming apparatus according to claim 13,
wherein the program further includes choices including the identifier of the individual configuration information for each of the image forming apparatuses to be configured; and
the input unit displays a user interface including the choices, and accepts the input of a single identifier selected from among the choices as the identifier.

15. The image forming apparatus according to claim 13,
wherein the setting unit further sets the common configuration information as the configuration information for the image forming apparatus in the case where a common setting command for setting the configuration information for all of the image forming apparatuses to be configured is included.

16. The image forming apparatus according to claim 13,
wherein in the case where a second individual setting command for setting the individual configuration information associated with the identifier of the image forming apparatus in the image forming apparatus having that identifier is included, the setting unit further sets the individual configuration information associated with the identifier of that image forming apparatus as the configuration information of that image forming apparatus.

17. The image forming apparatus according to claim 13,
wherein the image forming apparatus further comprises a unit that generates association information associating the identifier of that image forming apparatus with the identifier of the set configuration information; and
the storing unit further stores the association information in the medium.

18. A non-transitory computer-readable medium on which is recorded a program for causing a computer to function as the information processing apparatus according to claim 8.

19. A non-transitory computer-readable medium on which is recorded a program for causing a computer to function as the image forming apparatus according to claim 13.

20. A non-transitory computer-readable medium on which is recorded a program for causing an image forming apparatus to function as:
an input unit that, in the case where a first individual setting command for setting individual configuration information associated with an identifier input when configuration information is set in the image forming apparatus is included, accepts an input of the identifier; and
a setting unit that sets the individual configuration information associated with the input identifier as the configuration information of the image forming apparatus.
